(19) United States
(12) Patent Application Publication
(10) Pub. No.: US 2013/0112185 A1
(43) Pub. Date: May 9, 2013

(54) CARRIER FOR A SILICON BLOCK, CARRIER ARRANGEMENT HAVING SUCH A CARRIER AND PROCESS FOR PRODUCING SUCH A CARRIER ARRANGEMENT

(71) Applicants: Michael Essich, Freudenstadt (DE); Marc Schuster, Freudenstadt (DE)

(72) Inventors: Michael Essich, Freudenstadt (DE); Marc Schuster, Freudenstadt (DE)

(73) Assignee: GEBR SCHMID GMBH, FREUDENSTADT (DE)

(21) Appl. No.: 13/810,132

(22) PCT Filed: Jul. 8, 2011
(86) PCT No.: PCT/EP11/61606

§ 371 Date: Jan. 14, 2013

(30) Foreign Application Priority Data
Jul. 15, 2010 (DE) 10 2010 031 364.5

(51) Int. Cl. B28D 5/00

(52) U.S. Cl. CPC B28D 5/0082
USPC 125/35; 156/292; 156/249

(57) ABSTRACT

A carrier (13) for a silicon block (31) is designed to be firmly connected as part of a carrier arrangement (11), together with a lower carrier part (25), to the silicon block (31), and to be moved together therewith for machining by sawing, cleaning or the like. The underside of the carrier (13), which points towards the silicon block (31), has a plurality of channels (29), as does the lower carrier part (25) bonded thereto, the channels (29) in each case lying one above another. Water is introduced into the channels (29) in the carrier (13) from above and can run through sawing slots in the lower carrier part (25) between the wafers of the sawn-up silicon block (31) for cleaning purposes.

### FIELD OF USE AND PRIOR ART

The invention relates to a carrier for a silicon block, to a carrier arrangement and to a method for producing such a carrier arrangement.

It is known from DE 102009023121 A1 and DE 102009023122 A1 to produce a carrier for a silicon block from plastic or from ceramic. The carrier serves for the better handling of the silicon block during the various work steps, in particular during sawing, the silicon block being glued to the underside. Continuous inner longitudinal channels are integrated into such a carrier. These longitudinal channels are sawn from below when the silicon block is being sawn up. It thereby becomes possible to introduce water or other cleaning fluid into the longitudinal channels, so that it then enters interspaces between the individual sawn wafers from above and flushes out sawing residues there.

The cleaning action achieved thereby is highly advantageous. However, introducing the integrated longitudinal channels into the carriers made from the said materials constitutes a considerable outlay.

### OBJECT AND SOLUTION

The object on which the invention is based is to provide a carrier mentioned in the introduction, a corresponding carrier arrangement and a method for producing such a carrier arrangement, by means of which problems of the prior art can be solved and, in particular, an advantageous, cost-effective and process-reliable method for producing and using such a carrier can be provided.

This object is achieved by means of a carrier having the features of Claim 1, a carrier arrangement having the features of Claim 9 and a method for producing such a carrier arrangement having the features of Claim 14. Advantageous and preferred refinements of the invention are the subject-matter of the further claims and are explained in more detail below. In this case, many of the following features are mentioned only with regard to the carrier or only with regard to the carrier arrangement or only with regard to the method. However, they are intended to be applicable, irrespective of this, both to the carrier and to the carrier arrangement or to the method. The wording of the claims becomes the content of the description by virtue of express reference.

There is provision whereby the carrier is designed to be fixedly connected as part of a carrier arrangement to a silicon block which is usually quite heavy and weighs several kg. In this case, the carrier does not yet have to be fixedly connected directly to the silicon block or there is provision whereby it is not fixedly connected directly to the silicon block. For this purpose, a carrier lower part, explained in more detail below, is advantageously provided, which is fastened to the bottom of the carrier, and the silicon block is fastened, in turn, to this carrier lower part, in particular firmly glued in a way known per se. The carrier arrangement is therefore divided in two in that the carrier, which is one part in the abovementioned prior art, in this case consists of two parts, to be precise the carrier and the carrier lower part. The carrier as part of the carrier arrangement can be connected to the carrier lower part, and this unit can, in turn, be connected to the heavy silicon block. The latter can be moved together with the carrier arrangement for machining by sawing, cleaning or the like.

The carrier itself may advantageously be designed to be fastened to movement devices, by means of which it is moved into a saw or into a cleaning device, advantageously by fastening means, such as screw connections or the like. The carrier has a plurality of depressions, channels or indentations on its underside pointing towards the silicon block. These are open downwards on the underside. They are then closed or covered later by the carrier lower part and are transformed as it were from open channels, which can easily be produced, into integrated inner longitudinal channels which are in turn in themselves very much more difficult to produce. The carrier lower part together with the silicon block is in turn intended, during sawing, to be sawn into as far as the said depressions and in any event until the complete separation of the individual wafers. The carrier together with a carrier lower part thus forms a carrier arrangement, such as is known in one-piece form from the prior art mentioned in the introduction.

Advantageously, a plurality of parallel open channels in the manner of grooves are provided in the underside of the carrier. Especially advantageously, they run in the longitudinal direction of the carrier and can preferably be regular distances from one another. Thus, for example, they may be 4 to 10 depressions or channels which advantageously run at the same distance from one another in the longitudinal direction of the carrier.

In an advantageous refinement to the invention, the underside of the carrier is even or flat and planar, with the exception of the said depressions, channels or indentations. In this case, there may be provision whereby the carrier has essentially a constant thickness and, in particular, is a kind of plate. Advantageously, as in the known carrier arrangements, it is elongate and rectangular as are usually also the silicon blocks.

In a refinement to the invention, on the top side of the carrier, fastening means may be provided, by which the carrier can be fastened to an abovementioned movement device or handling device. The composite structure consisting of the carrier arrangement and the silicon block can then be gripped on the fastening means and moved. In a preferred refinement to the invention, the fastening means are designed as fastening projections having threaded bores. Especially preferably, they may in this case point upwards for a screw-in direction perpendicular to the carrier. However, many other different fastening means may be envisaged and are known to a person skilled in the art.

The carrier may advantageously consist of metal. Especially advantageously, it is made from steel or high-grade steel. Its dimensions may correspond in terms of length and width to conventional carrier arrangements and, above all, depend on the silicon blocks to which it is to be connected. The thickness of the carrier may vary between 1 cm and 3 cm, for example amount to about 2 cm. The heavy silicon blocks can thus be easily held and transported. The length of said carrier may be between 20 cm and 50 cm, or even slightly more under certain circumstances. In general, there may advantageously be provision whereby the carrier or at least a rectangular carrier plate which essentially forms it is one part and in one piece. The abovementioned fastening means can then be fastened to the carrier plate subsequently or else even be worked out in one piece or integrally formed.

The said depressions, channels or indentations may basically have any desired cross section. Advantageously, they are rectangular or round, in particular semicircular. They can be produced by milling.

In yet a further refinement to the invention, the depressions, channels or indentations may be closed downwardly, but closed so as to be liquid-permeable.

This may take place just above the underside. Closure may advantageously take place by means of a type of perforated grid or perforated plates. This liquid-permeable closure serves essentially as a kind of diffuser or distributor. Thus, water introduced into the depressions can emerge, distributed approximately informally, from the depressions downwards and enter the interspaces between the wafers via the sawing gaps in the carrier lower parts fastened to the bottom of the carrier. It can thus be ensured that, even when water is introduced at only one or two points for the depression or channel, an approximately uniform entry of water into the saving gaps between the wafers takes place.

One possibility, known from the prior art, for introducing water into the depressions in a finished carrier arrangement or for making them accessible is via the start and end orifices of the longitudinal channels which have been obtained. A further advantageous possibility is that the depressions in the carrier and therefore the integrated longitudinal channels are accessible from above or from its top side. For this purpose, inflow channels may be provided in the carrier. Advantageously, such inflow channels connect a plurality of depressions, channels or indentations to one another. This therefore means that they are formed, for example, transversely to the direction of the run of the depressions and are also incorporated on the underside. They may be accessible through bores through the top side. In a further refinement, on the top side, projections may be provided which may have such an inflow channel or serve for connecting a water supply or the like.

The said action of distributing introduced water to the various depressions, in particular also by means of the abovementioned inflow channels, is based on the fact that, in the finished carrier arrangement, the carrier lower part is attached to the carrier. An advantageous possibility here is for the carrier to be glued to the carrier lower part. The carrier lower part is a wearing part used once only, since it is also sawn into when the silicon block is being sawn up. In order to remove it from the carrier, the adhesive bond can be released in a way customary per se, for example chemically or thermally. The carrier can then be cleaned of adhesive residues on its underside and thereafter be glued to a new carrier lower part again. A new silicon block can be connected to this new carrier arrangement, in particular also firmly glued to it, for subsequent machining steps, such as sawing, or cleaning.

In a carrier arrangement according to the invention, the carrier is metallic, and on its underside a carrier lower part is fastened, to which, in turn, a heavy silicon block can be attached, for example permanently and solidly by firm gluing. The carrier lower part consists of non-metallic material and has depressions, channels or indentations or grooves on its top side connected to the carrier. These may correspond in terms of shape or formation to the depressions, channels or indentations or grooves, such as were described above for an advantageous configuration of the carrier. In this case, the carrier itself does not necessarily have to be provided with such depressions on its underside. It is perfectly obvious that, after the carrier is connected to a carrier lower part, a carrier arrangement in the form of a plate is obtained, which, like the known carrier arrangements and those mentioned in the introduction, has one or advantageously a plurality of integrated longitudinal channels which are sawn in when a silicon block fastened to the bottom of the carrier arrangement is being sawn up. By water being introduced into the longitudinal channels, the known advantageous cleaning action already described can then take place again. Even in the case of this relatively simple design of the carrier and carrier lower part, there is the possibility of removing the sawn-up and used carrier lower part from the carrier and of fastening a new carrier lower part to it. Thus, not only can the carrier be used again but, above all, it is also very much easier to make the depressions, channels or indentations in the carrier lower part and, in particular, also on the carrier itself on its underside when this is a freely accessible surface. In the case of a carrier made from metal, they can be milled in. In the case of a carrier lower part made from non-metallic material, advantageously glass or ceramic, they can be made, during production by extrusion, by means of a corresponding profile. Owing to the connection of the carrier and carrier lower part, depressions present on an open side become an integrated channel or longitudinal channel. The depressions, channels or indentations in the carrier lower part are therefore important or are indispensible here. Although they are advantageously provided in the carrier or on its underside, this does not have to be so.

In general, the said depressions, channels or indentations may have a depth of a few millimetres, for example 3 mm to 12 mm. Their width may likewise amount to a few millimetres, advantageously 3 mm t 15 mm.

Especially advantageously, such a carrier lower part is used in a carrier arrangement according to the invention having a carrier, mentioned in the introduction, which has depressions formed in a matching way on its underside. This means that they run exactly one above the other and, in particular, also have exactly the same width. Furthermore, it is possible that they have exactly the same shape.

The carrier lower part should occupy the same area as the carrier itself, that is to say be approximately the same size. Advantageously, they also have a similar thickness, for example the few centimetres mentioned in the introduction.

These and further features may be gathered not only from the claims, but also from the description and the drawings, while the individual features can in each case be implemented separately or severally in the form of sub-combinations in an embodiment of the invention and in other fields and constitute advantageous and independently patentable versions for which protection is claimed here. The subdivision of the application into individual sections and intermediate headings do not restrict the general validity of the statements made under these.

### BRIEF DESCRIPTION OF THE DRAWINGS

Exemplary embodiments of the invention are illustrated diagrammatically in the drawings and are explained in more detail below. In the drawings:

FIG. 1 shows a sectional illustration through a carrier arrangement consisting of a carrier and of a carrier lower part not yet arranged on its underside,

FIG. 2 shows an illustration of the underside of the carrier from FIG. 1 with individual outlet holes,

FIG. 3 shows a top view of the carrier lower part with longitudinal channels matching the outlet holes according to FIG. 2,

FIG. 4 shows a sectional illustration similar to FIG. 1 with the carrier and carrier lower part joined together as a carrier arrangement and with a silicon block on the carrier lower part,

FIG. 5 shows an illustration of the underside of a modification of the carrier similar to FIG. 2 with continuous longitudinal channels which are covered by a perforated grid, and

FIG. 6 shows a section similar to FIG. 1, greatly enlarged, with an illustration of a perforated grid above an outlet channel.

### DETAILED DESCRIPTION OF THE EXEMPLARY EMBODIMENTS

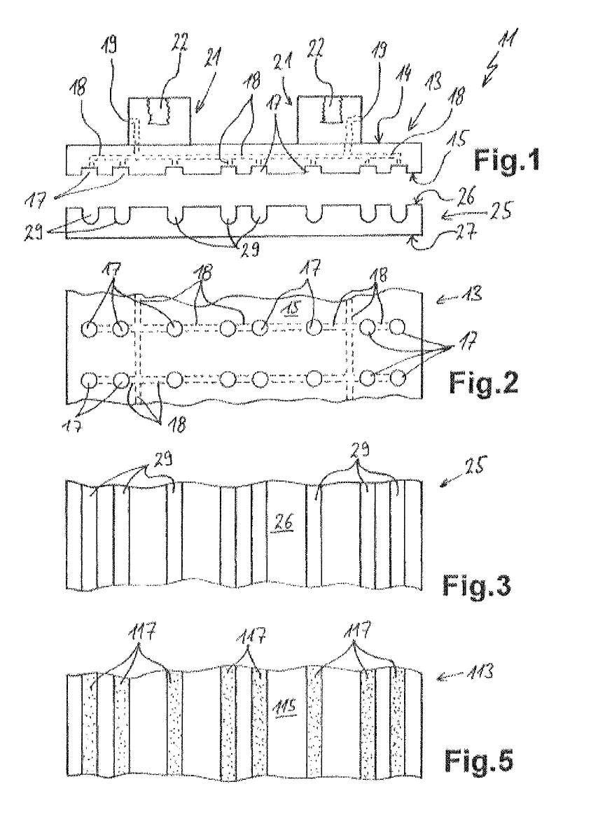

FIG. 1 illustrates a carrier arrangement 11, such as is just being assembled or produced. The carrier arrangement 11 has a carrier 13 in the form of an elongate rectangular plate, the carrier 13 being cut along its width, for example halved in length. It has a carrier top side 14 and a carrier underside 15, the latter being essentially even or planar. The stable carrier 13 advantageously consists of steel or tool steel or high-grade steel and can generally be between 20 cm and 50 cm long, under certain circumstances also longer.

A plurality of outlet holes 17 are provided on the carrier underside 15 and can be seen from the illustration in FIG. 2 as round holes. They therefore penetrate through the carrier underside 15, so that the latter is even or planar with the exception of the outlet holes 17. The outlet holes 17 are connected to one another by means of feed lines 18 in the carrier 13, which are illustrated by dashes in FIGS. 1 and 2. The connection pattern may therefore be as illustrated here, but may also deviate from this, in particular with markedly more outlet holes 17 towards the middle region for cleaning which is improved there above all. For production, the feed lines 18 may, for example, be drilled into the carrier 13 from the side, and these orifices then closed again on the outside.

In the upper region of the carrier 13, the feed lines 18 merge upwards into two connections 19 on the left and right. The connections 19 are located in fastening projections 21 and can be connected in a way not illustrated to water or cleaning-fluid feed lines. Furthermore, the fastening projections 21 have in each case a central thread 22 to which the carrier arrangement 11 can be fastened in a known way.

Advantageously, the carrier 13 has four such fastening projections 21 on its carrier top side 14. Thus, four connections 19 to the feed lines 18 may also be provided, but they may be more or fewer. The outlet holes 17 may have a diameter of a few millimetres, for example 1 mm to 6 mm preferably about 3 mm to 5 mm.

The carrier lower part 25 illustrated in FIG. 1 is advantageously of similar size to the carrier 13 in terms of the length and width dimensions, a top side 26 and an underside 27 being basically planar. However, while the underside 27 is designed to be advantageously completely planar and without interruptions or recesses or projections, the top side 26 has a plurality of open channels 29. These are drawn with advantageously straight extent over the entire top side 26 from the front to the rear end of the carrier lower part 25 and run parallel to one another, although at different distances from one another. This can be seen from the top view of the carrier lower part 25 according to FIG. 3. The carrier lower part 25 is advantageously made from a glass or ceramic material, especially advantageously from glass, alternatively from plastic.

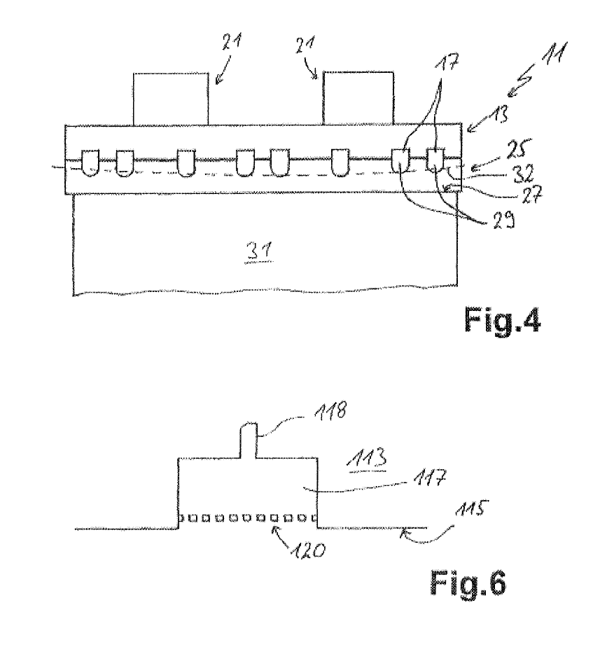

As shown in FIG. 1, the channels 29 are arranged exactly such that they correspond to the rows of outlet holes 17 in the longitudinal direction of the carrier 13 or, in the assembled state, are located exactly below the channels 29. This can be seen below from FIG. 4. The width of the channels 29 may also lie approximately in the region of the diameter of the outlet holes 17, they may alternatively also deviate somewhat from this. However, the channels 29 are in each case identical to one another and advantageously have a rounded cross section, for example semicircular or semioval. They are even advantageously somewhat deeper than they are wide.

FIG. 4 illustrates a simplified illustration of the assembled or fitted-together carrier arrangement 11. Here, the carrier lower part 25 is fastened or glued by means of its top side 26 to the carrier underside 15 of the carrier 13.

On account of the material combination of steel for the carrier 13 and of glass or ceramic for the carrier lower part 25, an adhesive customary for this purpose would be used for gluing by means of which glass or ceramic beams, as they are known in the prior art, are also glued to a carrier made from steel. These beams are then detached again later, as is also explained below.

The outlet holes 17 in the carrier 13 lie exactly above the channels 29 of the carrier lower part 25. A heavy silicon block 31 is fastened to the carrier lower part 25 or its underside 27, specifically, once again, firmly glued. This firm gluing also takes place as is known in the prior art and has the advantage of the secure holding of the heavy silicon block, and also the possibility of detachment at a later time. The carrier lower part 25 is then no longer usable in any case; only the carrier 13 remains usable.

The carrier arrangement 11 from FIG. 4 thus corresponds essentially to a carrier arrangement known from the prior art mentioned in the introduction, to be precise with the internal and virtually integrated longitudinal channels. These are made essentially by the channels 29. They may be closed outwardly at the ends or orifices at the end, for example by means of plugs or the like, so that the water is discharged only through the sawing gaps between the wafers for improved cleaning, but this does not have to be so.

By the silicon block 31 being sawn up, it is separated into individual silicon discs or wafers. A sawing line 32, as far as which a sawing wire reaches or as far as which sawing is carried out is illustrated by dashes. In this case, it can be seen that all the longitudinal channels 29 are sawn in from below and therefore the same cleaning effect can be achieved as is also known from the prior art mentioned in the introduction. To that extent, reference is made to this.

One of the advantages of the invention, which is also shown in this exemplary embodiment, is that these channels 29 can be supplied or flooded with water or cleaning fluid by means of the connections 19, feed lines 18 and outlet holes 17 above them. Infeed can take place much more uniformly through the outlet holes 17 arranged in a distributed way, whereas, in the prior art mentioned in the introduction, this was only possible via the two ends or orifices of the channels 29. A better cleaning action is therefore also possible. There may precisely advantageously be provision whereby the start and end orifices, to be seen in FIG. 4, of the channels 29 are closed, so that water or cleaning fluid can actually emerge only through the sawn-up wafers of the silicon block 31.

A further great advantage of the invention is that a carrier lower part 25 may be designed as a wearing part, since it is sawn up, that is to say is in turn made from glass, ceramic or a similar material or even from plastic. By the channels 29 being provided on its top side 26, they can also be produced much more easily than in the case of closed integrated longitudinal channels, as known in the prior art, the channels 29 advantageously also being introduced even during the production of the carrier lower part 25. This may take place, for example, without an additional work step, during continuous casting or the like.

The carrier 13 itself is not a wearing part and can be reused frequently. After the removal of the sawn-up wafers, the used or sawn-up carrier lower part 25 simply has to be removed by releasing the adhesive bond. The carrier underside 15 can then be cleaned and be glued to a new carrier lower part 25.

Furthermore, even in the case of a carrier 13 made from steel, it is easier to produce the guidance of water, that is to say to form the outlet holes 17 and the feed lines 18, together with the connections 19. They can in each case be drilled in a known way. Since the carrier 13 can be reused frequently, it is also worthwhile to provide the relatively complicated system of the outlet holes 17, together with the feed lines 18 and connections 19.

FIG. 5 illustrates an alternative embodiment of a carrier 113, similar to FIG. 3, to be precise as a view of a carrier underside 115 of the carrier 113. Here, instead of the individual outlet holes 17 according to FIG. 2, a plurality of long outlet channels 117 are provided in the longitudinal direction of the carrier 113. These outlet channels 117 thus correspond to the channels 29 in the carrier lower part 25 according to FIGS. 1 and 3. These outlet channels 117 are even easier to produce than the multiplicity of outlet holes 17 according to FIGS. 1 and 2, for example by corresponding milling or cutting.

On the one hand, it is possible in one variant that the outlet channels 117 are simply open and water delivered by the feed lines, not illustrated here, emerges arbitrarily into the outlet channels 117 and from there into the directly adjoining channels 29 in the top side of the carrier lower part 25.

For somewhat better distribution of water delivered, there may be provision, as shown in the enlarged sectional illustration of FIG. 6, whereby a perforated grid 120 is inserted as it were into the outlet channels 117. This may be a press fit or, alternatively, gluing or screwing. The perforated grids 120 as it were cover all the outlet channels 117, that is say are located between these and the channels 29 in the top side of a matching carrier lower part 25. The perforated grids 120 have a multiplicity of holes, advantageously with a very short distance between them. Thus, for example, the holes may have a diameter of about 1 mm and have a distance between them of 1 mm to 3 mm, but sometimes even in each case some are more or some are less.

The advantage of these holes in the perforated grid 120 is that they have a highly distributing action for the water introduced from above, so that, irrespective of how far a specific point is from a feed line, they give rise to a water inflow distributed uniformly over the length of the channels 29. It can be seen from FIG. 6 that, in the space in the outlet channel 117 above the perforated grid 120, water can be distributed, unimpeded over the length of the outlet channel and emerge approximately uniformly downwards. The cleaning action on all the sawn wafers of the silicon block 31 is therefore identical. Thus, although a multiplicity of feed lines 18 branched from one another may still be provided according to FIGS. 1 and 2, it does not have to be as complicated as that. Sometimes, even one feed line extending transversely with respect to the outlet channels 117 may be sufficient and has an orifice for each of them, and even this transversely running feed line need have only a single connection. Thus, not only is connection simplified, but also the production of the carrier 113 itself.

In a version not illustrated here, but easily imaginable from FIG. 4, a carrier has no holes at the top or channels or the like on its underside, but, instead, is a closed or massive steel plate having a planar and closed underside without recesses. A carrier lower part according to FIG. 4 is fastened to it by firm gluing. Since the carrier lower part has longitudinal channels on its top side, as described above, integrated longitudinal channels can thus also be produced, as described in the prior art mentioned in the introduction. However, their production is considerably simpler, since it is only the carrier lower part which needs to have the channels on its top side and therefore on an outside, thus simplifying production. The introduction of water or cleaning fluid then takes place at the ends of the channels via their orifices located there, as is likewise described in the prior art.

1. A carrier for a silicon block, the carrier forming part of a carrier arrangement and being designed to be connected fixedly to the silicon block and to be moved, together with the silicon block, for machining, wherein the carrier comprises a plurality of depressions, channels or indentations on its underside to point towards the silicon block.

2. The carrier according to claim 1, wherein the plurality of channels comprise parallel grooves provided in the underside of the carrier.

3. The carrier according to claim 1, wherein the underside is even, with the exception of the depressions, channels or indentions, such that the carrier has an essentially uniform thickness.

4. The carrier according to claim 1, comprising fastening means on a top side of the carrier for fastening to a movement device.

5. The carrier according to claim 1, it wherein the carrier consists of metal.

6. The carrier according to claim 1, wherein the carrier consists essentially of a rectangular carrier plate which is formed in one piece.

7. The carrier according to claim 1, wherein the depressions, channels or indentations or grooves are closed by perforated grids or plates so as to be liquid-permeable.

8. The carrier according to claim 1, wherein the depressions, channels or indentations or grooves in the underside are accessible from above through inflow channels.

9. A carrier arrangement having a carrier according to claim 1, the carrier being metallic, a carrier lower part being fastened to the underside of the carrier for attaching a silicon block thereto, the said carrier lower part consisting of non-metallic material, the carrier lower part having depressions, channels or indentations or grooves on its top side connected to the carrier.

10. The carrier arrangement according to claim 9, wherein the carrier lower part consists of glass or ceramic.

11. The carrier arrangement according to claim 9, wherein the depressions, channels or indentations or grooves have a depth of 3 mm to 12 mm, and have a width of 3 mm to 15 mm.

12. The carrier arrangement according to claim 9, wherein the grooves or depressions are provided both on the underside of the carrier and on the top side of the carrier lower part and run one above the other, the grooves or depressions having the same width.

13. The carrier arrangement according to claim 9, wherein the carrier and the carrier lower part are of equal size.

14. A method for producing a carrier arrangement according to claim 9, comprising gluing a carrier for a silicon block, the carrier having a plurality of depressions, channels or indentions on its underside to a carrier lower part.

15. The method according to claim 14, comprising cleaning a used carrier arrangement after a sawn-up silicon block is detached therefrom, by chemically or thermally releasing the adhesive bond between the carrier and carrier lower part, and cleaning the carrier of adhesive residues or the like, in particular on its underside, and such that the carrier can subsequently be glued to a new carrier lower part.

16. The carrier according to claim 2, wherein the parallel grooves extend in a longitudinal direction of the carrier, at regular distances from one another.

17. The carrier according to claim 4, wherein the fastening means are configured as upwardly pointing fastening projections having threaded bores.

18. The carrier according to claim 5, wherein the metal is selected from the group consisting of steel and high-grade steel.

19. The carrier according to claim 8, wherein the inflow channels connect a plurality of depressions, channels or indentations to one another, and are accessible from a top side of the carrier.
